(19) United States
(12) Patent Application Publication
(10) Pub. No.: US 2008/0129917 A1
(43) Pub. Date: Jun. 5, 2008

(54) INVERTER UNIT AND LIQUID CRYSTAL DISPLAY HAVING THE SAME

(76) Inventor: Seung Chul Jeong, Seongnam-Si (KR)

Correspondence Address: F. CHAU & ASSOCIATES, LLC, 130 WOODBURY ROAD, WOODBURY, NY, 11797, US

(21) Appl. No.: 11/928,265

(22) Filed: Oct. 30, 2007

(30) Foreign Application Priority Data
Dec. 5, 2006 (KR) 10-2006-0122114

(51) Int. Cl. G02F 1/1333; G09G 3/36

(52) U.S. Cl. 349/58; 345/102

(57) ABSTRACT

An inverter unit and a liquid crystal display having the inverter unit. The liquid crystal display includes a liquid crystal display panel, a chassis receiving the liquid crystal display panel, an inverter unit fastened to the chassis, and combining parts fastening the inverter unit to the chassis. The inverter unit includes an inverter, a substrate on which the inverter is mounted, fixing parts supporting the substrate, and fastening parts fastening the substrate to the fixing parts. The fixing parts include a base plate and a supporting plate extending at an angle from the base plate and the substrate is disposed on the supporting plate.

### CROSS-REFERENCE TO RELATED APPLICATION

The present application claims priority to Korean Patent Application No. 2006-0122114 filed on Dec. 5, 2006, the contents of which are incorporated herein by reference in their entirety.

### BACKGROUND OF THE INVENTION

1. Technical Field

The present disclosure relates to an inverter unit and a liquid crystal display having the same, and more particularly, to an inverter unit that does not practically change the shape of a liquid crystal display and is easy to fasten to a chassis, and a liquid crystal display having the inverter unit.

2. Discussion of Related Art

Liquid crystal displays (LCDs) are increasing in usage due to having characteristics such as being light weight, and thin, requiring low-power activation, and exhibiting full-color and high resolution. Liquid crystal displays are currently used in lap top computers, note book computers, PDAs, telephones, TVs, audio/video devices, etc. Liquid crystal displays are designed to display desired images on their panels by controlling the amount of light passing through a liquid crystal layer in response to image signals applied to a plurality of control switches, which may be arranged in a matrix. Such a liquid crystal display requires a light source, such as back light, because it does not emit light by itself. A lamp has been used as a light source and an inverter unit including an inverter is mounted in a liquid crystal display device to supply power to the lamp.

Known liquid crystal displays may have a chassis with fastening parts and an inverter unit is fastened to the chassis by the fastening parts. However, a chassis can be deformed to have uneven surfaces during the forming and punching processes when forming fastening parts for the chassis. As a result, a gap is created between the chassis and the inverter unit.

### SUMMARY OF THE INVENTION

According to an embodiment of the present invention, an inverter unit comprises an inverter, a substrate on which the inverter is mounted, fixing parts supporting the substrate and fastening parts fastening the substrate to the fixing parts, wherein the fixing parts comprise a base plate and a supporting plate extending at an angle from the base plate and the substrate is disposed on the supporting plate.

The inverter unit may further comprise guiding parts that guide the substrate onto the fixing parts.

The fastening parts nay comprise a first fastening hole formed in the supporting plate, a second fastening hole formed in the substrate to correspond in position to the first fastening hole, and a first fastening member inserted into the first and second fastening hole.

The fastening parts may comprise the first fastening hole formed in the supporting plate, and a second fastening member formed on the substrate and inserted into the first fastening hole.

The fastening parts may comprise a third fastening hole formed in the base plate, and a third fastening member positioned on the substrate, wherein a portion of the third fastening member is inserted into the third fastening hole.

The base plate may have a combining hole for receiving a protrusion formed on a side of a chassis of a liquid crystal display.

The inverter unit may further comprise a plurality of circuit components, wherein the inverter and the circuit components are mounted on opposite sides of the substrate. Alternatively, the inverter may mounted on one side of substrate, and the plurality of circuit components may be mounted on the same side as the inverter and on a side opposite to that on which the inverter is mounted.

The guiding parts may comprise a guide hook fastened to the substrate, and a guide groove formed on the base plate on which the guide hook is disposed.

According to an embodiment of the present invention, a liquid crystal display comprises a liquid crystal display panel, a chassis receiving the liquid crystal display panel, an inverter unit fastened to the chassis and combining parts fastening the inverter unit to the chassis, wherein the inverter unit comprises an inverter, a substrate on which the inverter is mounted, fixing parts supporting the substrate, and fastening parts fastening the substrate to the fixing parts. The fixing parts comprise abase plate and a supporting plate extending from the base plate, and the substrate is disposed on the supporting plate.

The combining parts may comprise a combining hole formed in the base plate, and a protrusion formed on the chassis and inserted into the combining hole.

The liquid crystal display may further comprise guiding parts that guide the substrate onto the supporting plate.

The chassis can be an upper chassis that is disposed on the liquid crystal display panel.

The fastening parts may comprise a first fastening hole formed in the supporting plate, and a first fastening member formed on the substrate and inserted into the first fastening hole.

The fastening parts may comprise the first fastening hole formed in the supporting plate, a second fastening hole formed in the substrate to correspond in position to the first fastening hole, and a second fastening member inserted into the first and second fastening holes.

The fastening parts may comprise a third fastening hole formed in the base plate, and a third fastening member positioned on the substrate, wherein a portion of the third fastening member is inserted into the third fastening hole.

The supporting plate may include two parts respectively formed at two ends of the base plate, and the guiding parts may be disposed between the two parts.

The guiding parts may be formed at two ends of the substrate, and the supporting plate may be disposed between the guiding parts.

The guiding parts may comprise a guide hook fastened to the substrate, and a guide hole formed in the chassis, wherein the guide hole is formed to have a corresponding position and size to those of the guide hook.

The guiding parts may further comprise a guide groove formed in the base plate, wherein the guide hook is disposed on the guide groove.

### BRIEF DESCRIPTION OF THE DRAWINGS

Embodiments of the present invention can be understood in more detail from the following descriptions taken in conjunction with the attached drawings in which:

FIGS. 1A and 1B are exploded perspective and assembled views, respectively, of an inverter unit according to an embodiment of the invention;

FIG. 2 is a perspective enlarged partial bottom view of the inverter unit shown in FIG. 1A;

FIGS. 3A and 3B are exploded perspective and assembled views, respectively, of an inverter unit according to an embodiment of the invention;

FIGS. 4A and 4B are exploded perspective and assembled views, respectively, of an inverter unit according to an embodiment of the invention;

FIGS. 5A and 5B are exploded perspective and assembled views, respectively, of an inverter unit according to an embodiment of the invention;

FIG. 6 is a perspective view of a liquid crystal display including an inverter unit according to an embodiment the invention;

FIG. 7 is an exploded perspective view of a liquid crystal display including an inverter unit according to an embodiment of the invention;

FIGS. 8A and 8B are perspective and enlarged views, respectively, illustrating fastening of a fixing portion of an inverter unit to a chassis of a liquid crystal display, according to an embodiment of the present invention; and

FIGS. 9A and 9C are perspective, bottom, and cross-sectional views, respectively, illustrating fastening of a fixing portion to a substrate of an inverter unit, according to an embodiment of the present invention.

### DESCRIPTION OF EXEMPLARY EMBODIMENTS

Exemplary embodiments of the invention are described in detail hereafter with reference to accompanying drawings. The present invention, however, is not limited to the embodiments described herein, but maybe modified in a variety of ways without departing from the scope and spirit of the invention.

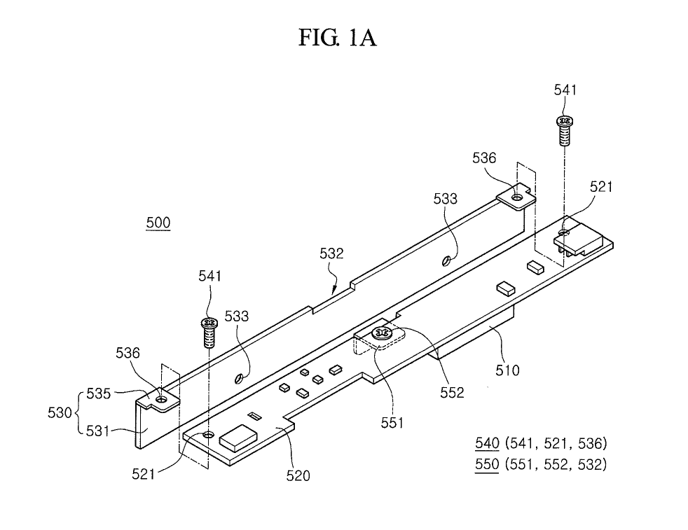

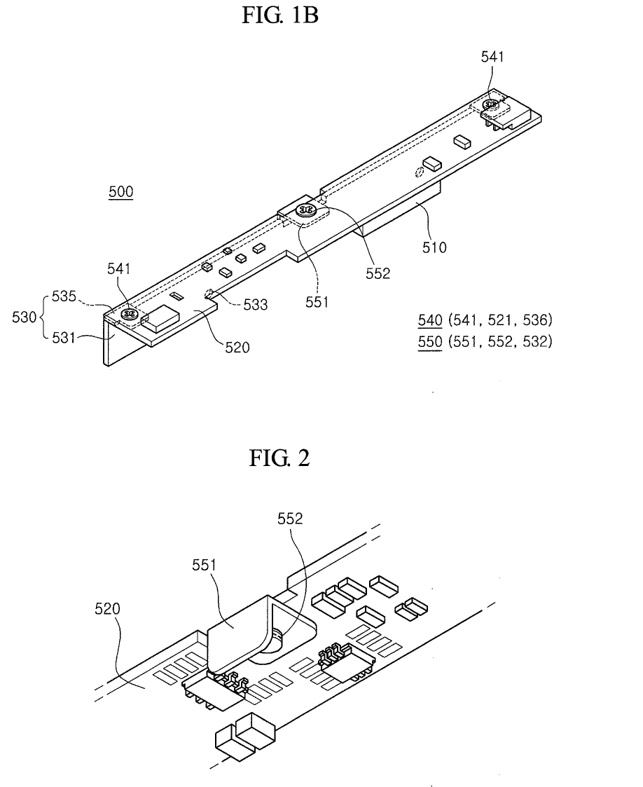

FIGS. 1A and 1B are exploded perspective and assembled views of an inverter unit according to an embodiment of the invention. FIG. 2 is a perspective enlarged partial bottom view of the inverter unit shown in FIG. 1A.

Referring to FIGS. 1A to 2, an inverter unit 500 comprises an inverter 510, a substrate 520, fixing parts 530, fastening parts 540, and guiding parts 550. The inverter 510 is mounted on the substrate 520, the substrate 520 is fixed by the fixing parts 530, and the fastening parts 540 fasten the substrate 520 to the fixing parts 530. The guiding parts 550 guide the substrate 520 to align the substrate with the fixing parts 530.

A lamp of cold cathode ray tube type for a light source in liquid crystal displays is activated by alternating current and the inverter 510 converts direct current supplied from the outside into alternating current and outputs the alternating current to activate the lamp.

The substrate 520 may be a printed circuit board with circuit patterns and the inverter 510 is mounted on the substrate 520. In addition to the inverter 510, a variety of circuit components may be additionally mounted on the substrate 520, such as a transformer (not shown) for changing the voltage level of the outputted alternating current and a controller (not shown) for controlling the inverter.

The fixing parts 530 comprise a base plate 531 and a supporting plate 535 bent from the base plate 531. A supporting plate 535 is formed one end and the other end, i.e. two ends of the base plate 531 and extending perpendicular to the base plate 531. The substrate 520 is disposed on the supporting plate 535 and fastened by the fastening parts 540. The base plate 531 is combined with a chassis of a liquid crystal display (described later) and includes combining hole 533 for receiving a protrusion formed on a side of a chassis.

The fastening parts 540 fasten the substrate 520 to the fixing parts 530. The fastening parts 540 comprise a first fastening hole 536 formed in the supporting plate 535, a second fastening hole 521 formed in the substrate 520 and corresponding to the position and size of the first hole 536, and a first fastening member 541 inserted in the first and second fastening holes 536, 521 to fasten the substrate 520 to the fixing parts 530. According to an embodiment, the first and second fastening hole 536, 521 are threaded holes, the first fastening member 541 is a bolt, and the substrate 520 is thread-fastened to the fixing parts 530 by the bolt.

The guiding parts 550 comprise a guide hook 551, a fixing member 552, and a guide groove 532. The guide hook 551 is formed in an L-shape and fixed to the rear side of the substrate 520, i.e. the surface on which the inverter 510 is mounted. The guide groove 532 where the guide hook 551 is disposed is formed at the base plate 531. Alternatively, the guide groove 532 may be omitted when a guide groove is formed in the chassis of a liquid crystal display (described later).

According to the above configuration, the area of the fixing parts for supporting the substrate equipped with the inverter can be minimized. As a result, material costs are reduced and increased area of the substrate is available for additional components, which reduces the overall size of the inverter unit.

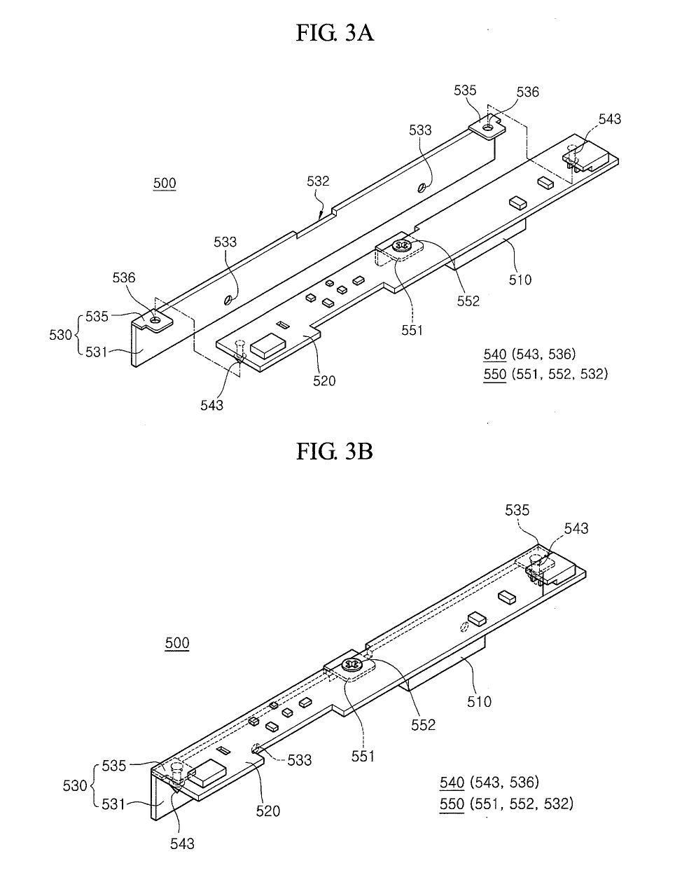

FIGS. 3A and 3B are exploded perspective and assembled views of an inverter unit according to an embodiment of the present invention. The inverter unit shown in FIGS. 3A and 3B is differs from the inverter unit shown in FIGS. 1A and 1B, with respect to, for example, the structure and shape of fastening part, but is the same or similar with respect to the other components.

Referring to FIGS. 3A and 3B, the inverter unit 500 comprises an inverter 510, a substrate 520, fixing parts 530, fastening parts 540, and guiding parts 550. The fastening parts 540 comprise a first fastening hole 536 formed in the supporting plate 535 and a second fastening member 543 formed at the substrate 520 corresponding to the position of the first fastening hole 536. The second fastening member 543 is a protrusion inserted into the first fastening hole 536 to fasten the substrate 520 to the fixing parts 530. Further, the second fastening member 543 is a protrusion including an arrowhead, but is not limited thereto and may be formed in a variety of shapes.

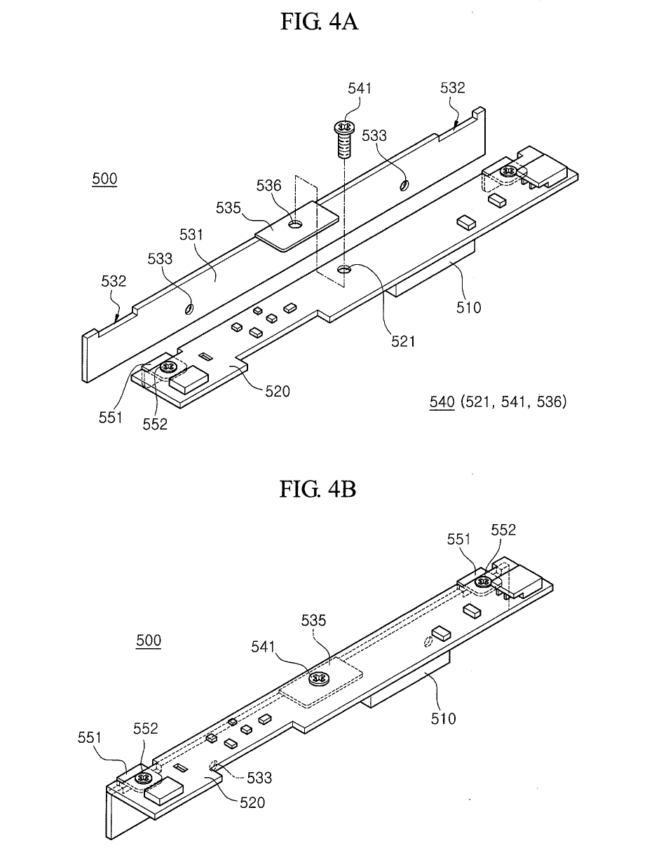

FIGS. 4A and 4B are exploded perspective and assembled views of an inverter unit according to an embodiment of the invention. The inverter unit shown in FIGS. 4A and 4B is different from the inverter unit shown in FIGS. 1A and 1B with respect to, for example, the configuration of the supporting plate and fastening parts, but is the same or similar with respect to other components.

Referring to FIGS. 4A and 4B, an inverter unit 500 comprises an inverter 510, a substrate 520, fixing parts 530, fastening parts 540, and guiding parts 550.

The fixing parts 530 comprise a base plate 531 and a supporting plate 535 extending, for example, perpendicularly from the base plate 531. According to the present embodiment, the supporting plate 535 is formed at the center of the base plate 531 and bent perpendicular to the base plate 531. The substrate 520 is disposed on the supporting plate 535 and fastened by the fastening parts 540.

The fastening parts 540 fasten the substrate 520 to the fixing parts 530 and comprise a first fastening hole 536 formed in the supporting plate 535, a second fastening hole 521 formed in substrate 520 corresponding to the position and size of the first fastening hole 536, and a first fastening member 541 inserted in the first and second fastening holes 536, 521 to fasten the substrate 520 to the fixing parts 530.

The guiding parts 550 comprise a guide hook 551, a fixing member 552, and a guide groove 532. A guide hook 551 is fixed at two ends of the substrate 520 by the fixing member 552 and the guide groove 532 may be formed corresponding to the guide hooks 551 at two ends of the base plate 531.

According to the above configuration, the area of the fixing parts for supporting the substrate equipped with the inverter is decreased.

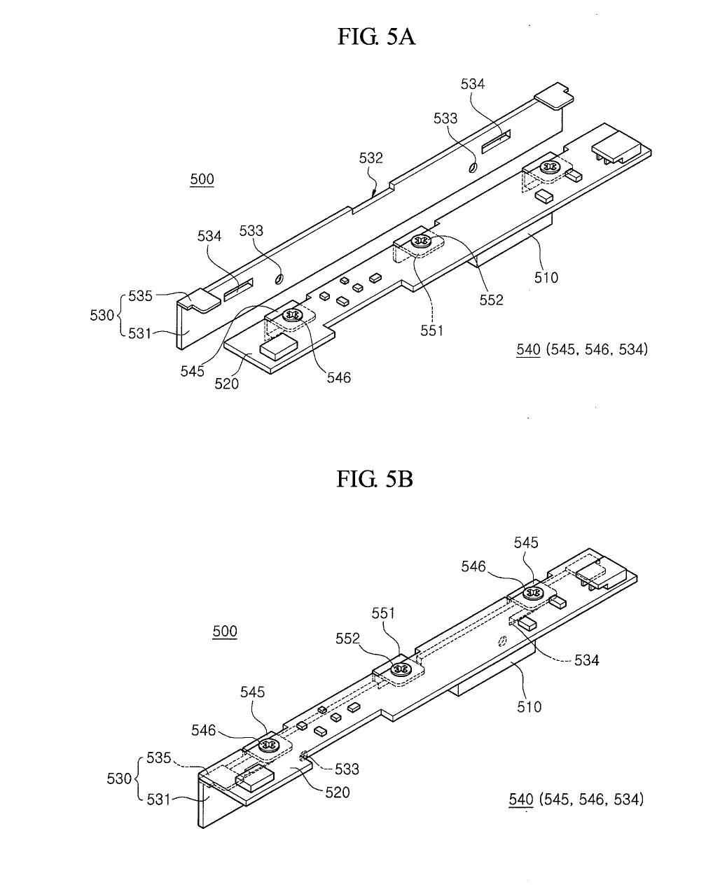

FIGS. 5A and 5B are exploded perspective and assembled views of an inverter unit according to an embodiment of the invention. The inverter unit shown in FIGS. 5A and 5B is different from the above embodiments with respect to, for example, the structure and shape of each fastening part, but is the same or similar with respect to other components.

Referring to FIGS. 5A and 5B, an inverter unit 500 comprises an inverter 510, a substrate 520, fixing parts 530, fastening parts 540, and guiding parts 550. According to the present embodiment, the fastening parts 540 comprise a third fastening hole 534 formed in a base plate 531 and a third fastening member 545 formed at the substrate 520. A portion of the third fastening member 545 is positioned in the third fastening hole 534. The third fastening member 545 is formed in an L-shape and a hook including a rising is formed at one end of the L-shape. The third fastening member can be mounted to the substrate 520 using a fixing member 546, or may be integrally formed with the substrate 520. The rising formed at the end of the third fastening member 545 is inserted and fastened in the third fastening hole 534 formed in the base plate 531.

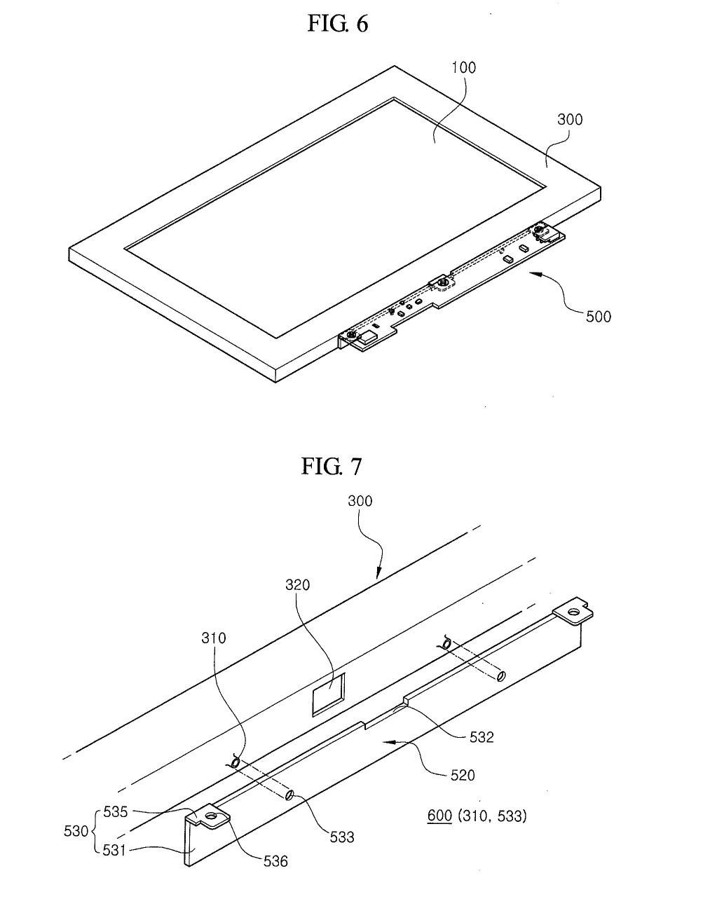

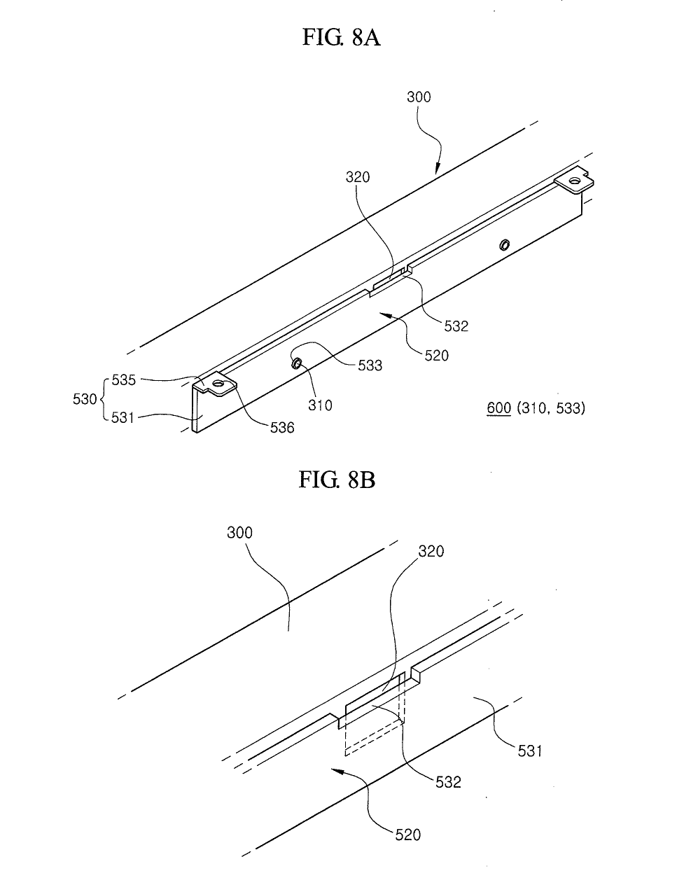

FIG. 6 is a perspective view of a liquid crystal display equipped with an inverter unit according to an embodiment of the invention and FIG. 7 is an exploded perspective view of a liquid crystal display equipped with the inverter unit according to an embodiment of the invention.

Referring to FIGS. 6 and 7, a liquid crystal display includes a liquid crystal display panel 100, an upper chassis 300 disposed surrounding the sides and covering a part of the upper surface of the liquid crystal display panel, and an inverter unit 500 fastened to a side of the upper chassis 300.

The liquid crystal display comprises the liquid crystal display panel 100, the upper chassis 300, the inverter unit 500 fastened to the upper chassis 300, and combining parts 600 for fastening the inverter unit 500 to the upper chassis 300.

The inverter unit 500, as described with reference to FIGS. 1A and 1B, comprises an inverter 510, a substrate 520, fixing parts 530, fastening parts 540, and guiding parts 550.

The fixing parts 530 comprise a base plate 531 and a supporting plate 535 bent from the base plate 531. A supporting plate 535 is formed at one end and the other end, i.e. two ends of the base plate 531 and extends perpendicular to the base plate 531. The substrate 520 is disposed on the supporting plates 535 and fastened to the fixing parts using the fastening parts 540.

The fastening parts 540 fasten the substrate 520 to the fixing parts 530. According to the present embodiment, the fastening parts 540 comprise a first fastening hole 536 formed in the supporting plate 535, a second fastening hole 521 formed in the substrate 520 corresponding to the position and size of the first fastening hole 536, and a first fastening member 541 inserted in the first and second fastening hole 536, 521 to fasten the substrate 520 to the fixing parts 530.

The guiding parts 550 comprise a guide hook 551, a fixing member 552, and a guide hole 320. The guide hole 320 is formed at a side of the chassis 300 corresponding to the position and size of the guide hook 551. As the guide hook 551 is inserted into the guide hole 320, it guides the substrate 520 to position it onto the supporting plates 535.

The combining parts 600, for fastening the inverter unit 500 to the upper chassis 300, comprise combining holes 533 formed in the base plate 531 and protrusions 310 formed at a side of the upper chassis 300. The protrusions 310 protrude toward the outside of the chassis 300 from the side and are inserted and fastened in the combining holes 533. In order to increase the fastening force, the protrusions 310 may be pushed after being inserted in the combining holes 533.

Since the inverter unit is fastened to the upper chassis as described above and the side of the upper chassis includes only the protrusions and the guide hole, forming and punching in manufacturing the upper chassis are correspondingly simplified and deformation of the chassis is decreased.

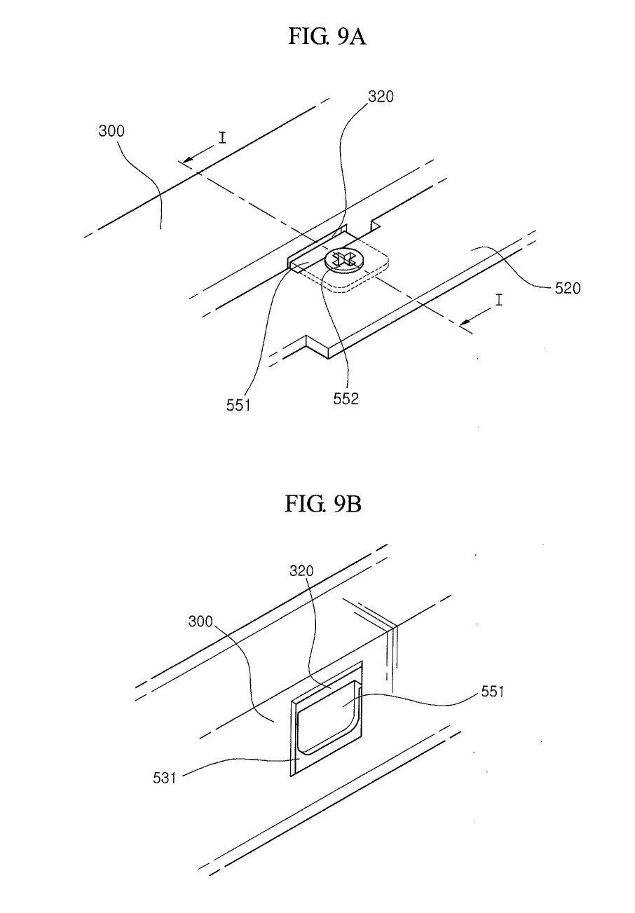

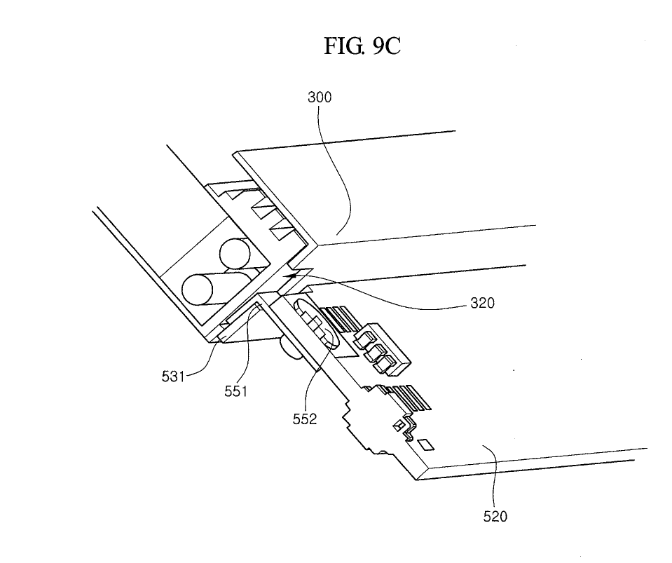

FIGS. 8A and 8B are perspective and enlarged views illustrating fastening of fixing parts of the inverter unit to the chassis of a liquid crystal display and FIGS. 9A and 9C are perspective, bottom, and cross-sectional views, respectively, illustrating fastening of the fixing parts to a substrate of an inverter unit. FIG. 9C is a cross-sectional view of FIG. 9A taken along the line I-I.

FIGS. 8A to 9C illustrate fastening of the inverter unit to the liquid crystal display and the status of the components in steps of the fastening process.

Referring to FIGS. 8A and 8B, the fixing parts 530 of the inverter unit are fastened to the upper chassis 300 by combining parts 600. When the fixing parts 530 are fastened to a side of the upper chassis 300, the base plate 531 covers a part of the guide hole 320 formed at the side of the upper chassis 300.

Referring to FIGS. 9A and 9C, after being inserted in the guide hole 320 at the side of the upper chassis 300, the guide hook 551, which is fixed to the substrate 520, is held in place by the base plate 531. As a result, the guiding parts 550 temporarily fix the substrate 520 on the supporting plate 535 of the fixing parts 530 and guide the substrate 520 to position it on the supporting plates 535, so that fastening with the fastening parts 540 is facilitated.

After being positioned on the supporting plates 535 by the guiding parts 550, the substrate 520 is fastened to the fixing parts 530 by the fastening parts 540.

After the fixing parts of the inverter unit are fastened to the upper chassis of the liquid crystal display, the substrate is positioned on the fixing parts and then the substrate is fastened to the fixing parts. However, the fastening order is not limited thereto and may be changed.

In the fastening process described in connection with FIGS. 8A-9C, although the liquid crystal display includes the inverter unit described in connection with FIGS. 1A-1B, it is to be understood that an inverter unit described in connection with any of FIGS. 3A-5B may be used.

Although exemplary embodiments of the present invention have been described herein, the invention is not limited thereto, and those skilled in the art will appreciate that various modifications, additions and substitutions are possible, without departing from the scope and spirit of the invention as hereinafter claimed.

According to an inverter unit and a liquid crystal display according to the embodiments of the invention, flatness of a chassis can be maintained by minimizing its deformation, and mounting of the inverter unit to the liquid crystal display is facilitated.

What is claimed is:

1. An inverter unit comprising:
an inverter;
a substrate on which the inverter is mounted;
fixing parts supporting the substrate; and
fastening parts fastening the substrate to the fixing parts,
wherein the fixing parts comprise a base plate and a supporting plate extending at an angle from the base plate and the substrate is disposed on the supporting plate.

2. The inverter unit of claim 1, further comprising guiding parts that guide the substrate onto the supporting plate.

3. The inverter unit of claim 1, wherein the fastening parts comprise a first fastening hole formed in the supporting plate, a second fastening hole formed in the substrate corresponding in position to the first fastening hole, and a fastening member inserted into the first and second fastening holes.

4. The inverter unit of claim 1, wherein the fastening parts comprise a fastening hole formed in the supporting plate, and a fastening member formed on the substrate and inserted into the fastening hole.

5. The inverter unit of claim 1, wherein the fastening parts comprise a fastening hole formed in the base plate, and a fastening member positioned on the substrate, wherein a portion of the fastening member is inserted into the fastening hole.

6. The inverter unit of claim 1, wherein the base plate includes a combining hole for receiving a protrusion formed on a chassis of a display device.

7. The inverter unit of claim 1, further comprising
a plurality of circuit components, wherein the inverter and the circuit components are mounted on respective sides of the substrate.

8. The inverter unit of claim 2, wherein the guiding parts comprise a guide hook fastened to the substrate, and a guide groove formed in the base plate, wherein a portion of the guide hook is disposed on the guide groove.

9. A liquid crystal display comprising:
a liquid crystal display panel;
a chassis receiving the liquid crystal display panel;
an inverter unit fastened to the chassis; and
combining parts fastening the inverter unit to the chassis, wherein:
the inverter unit comprises an inverter, a substrate on which the inverter is mounted, fixing parts supporting the substrate, and fastening parts fastening the substrate to the fixing parts,
the fixing parts comprise a base plate and a supporting plate extending from the base plate, and
the substrate is disposed on the supporting plate.

10. The liquid crystal display of claim 9, wherein the combining parts comprise a combining hole formed in the base plate, and a protrusion formed on the chassis, wherein the protrusion is inserted into the combining hole.

11. The liquid crystal display of claim 9, further comprising guiding parts that guide the substrate onto the supporting plate.

12. The liquid crystal display of claim 9, wherein the chassis is an upper chassis disposed on the liquid crystal display panel.

13. The liquid crystal display of claim 9, wherein the fastening parts comprise a fastening hole formed in the supporting plate, and a fastening member formed on the substrate and inserted into the fastening hole.

14. The liquid crystal display of claim 9, wherein the fastening parts comprise a first fastening hole formed in the supporting plate, a second fastening hole formed in the substrate corresponding in position to the first fastening hole, and a fastening member inserted into the first and second fastening holes.

15. The liquid crystal display of claim of claim 9, wherein the fastening parts comprise a fastening hole formed in the base plate, and a fastening member positioned on the substrate, wherein a portion of the fastening member is inserted into the fastening hole.

16. The liquid crystal display of claim 11, wherein the supporting plate includes two parts respectively formed at two ends of the base plate, and
the guiding parts are disposed between the two parts.

17. The liquid crystal display of claim 11, wherein the guiding parts are formed at two ends of the substrate, and
the supporting plate is disposed between the guiding parts.

18. The liquid crystal display of claim 11, wherein the guiding parts comprise a guide hook fastened to the substrate, and a guide hole formed in the chassis, and
the guide hole is formed to have a position and a size corresponding to a position and size of the guide hook.

19. The liquid crystal display of claim 18, wherein the guiding parts further comprise a guide groove formed in the base plate, wherein the guide hook is disposed on the guide groove.
